(19) United States
(12) Patent Application Publication
(10) Pub. No.: US 2015/0352618 A1
(43) Pub. Date: Dec. 10, 2015

(54) ADDITIVE MANUFACTURED ENHANCED SHEET BEND AND METHOD OF MANUFACTURE

(71) Applicant: United Technologies Corporation, Hartford, CT (US)

(72) Inventors: Wayde R. Schmidt, Pomfret Center, CT (US); William Werkheiser, East Hartford, CT (US)

(21) Appl. No.: 14/732,329

(22) Filed: Jun. 5, 2015

Related U.S. Application Data
(60) Provisional application No. 62/008,926, filed on Jun. 6, 2014.

(51) Int. Cl. B21D 5/00

(52) U.S. Cl. CPC B21D 5/00; B33Y 10/00

(57) ABSTRACT

A folded sheet assembly and method of manufacture includes a sheet having an un-folded state with a pre-determined bend-line. The sheet may be weakened along the bend-line to facilitate precise bending of the sheet and into a folded state. A segment of the assembly is additively manufactured to the bend for reinforcement. Weakening of the sheet along the bend-line may be achieved by placement of perforations through the sheet when in the unfolded state. The perforations may be filled by the segment when the sheet is in the folded state.

This application claims priority to U.S. Patent Appln. No. 62/008,926 filed Jun. 6, 2014.

### BACKGROUND

The present disclosure relates to sheet bends, and more particularly, to sheet bends enhanced through additive manufacturing.

There is an ongoing demand for low cost manufacturing technology, storage and packaging methodology, installation approaches, and low cost construction assembly methods suitable for industrial businesses. For instance, structures may be designed and shipped to installation or final manufacturing sites as a metal flat sheet. Once on-site, the sheet may be selectively folded to create a desired final structure or component.

Bending of sheet material at pre-specified bend locations is difficult to control because of bending tolerance variation and the accumulation of such defects over multiple bend applications. To assist in reducing such bend variation, it is known to form intermittent slits, perforations and/or grooves along, or close to, a pre-specified bend location, or bend-line. Non-limiting examples of such sheet bending is further taught in U.S. Patent Publication Number 2011/0059330, published on Mar. 10, 2011, and assigned to Industrial Origami, Inc. of Middleburg Heights, Ohio, and incorporated herein by reference in its entirety. Unfortunately, the slitting-based and grooving-based bending of sheet material may structurally weaken the bend and produce residual stresses due to plastic deformation. Yet further, slitting-based bending and other similar methods may further produce undesirable apertures, voids or cracks that communicate through the folded sheet assembly at the bend location, may be susceptible to corrosion and environmental exposure, and may retain sharp and aesthetically unpleasing edges.

### SUMMARY

A folded sheet assembly according to one, non-limiting, embodiment of the present disclosure includes a bend; and an additive manufactured segment located at the bend.

Additionally to the foregoing assembly a perforation is located along the bend and the segment fills at least a portion of the perforation.

In the alternative or additionally thereto, in the foregoing embodiment, the assembly includes a first sheet portion having a first edge face proximate to the bend; a second sheet portion engaged to the first sheet portion at the bend, and having a second edge face proximate to the bend; and wherein the segment is additively manufactured to at least the first and second edge faces.

In the alternative or additionally thereto, in the foregoing embodiment, the assembly includes an inner side defining a groove extending along the bend; an outer side generally in plastic deformation along the bend; and wherein the segment is additively manufactured to the second side at the bend.

In the alternative or additionally thereto, in the foregoing embodiment, the segment is cold sprayed.

In the alternative or additionally thereto, in the foregoing embodiment, the segment is produced through Kinetic Metallization.

In the alternative or additionally thereto, in the foregoing embodiment, the segment is cold sprayed.

In the alternative or additionally thereto, in the foregoing embodiment, the segment is produced through cold metal transfer.

In the alternative or additionally thereto, in the foregoing embodiment, the segment is additively manufactured through laser beam melting that relieves plastic deformation stress.

In the alternative or additionally thereto, in the foregoing embodiment, the segment is additively manufactured through laser beam melting that relieves plastic deformation stress.

In the alternative or additionally thereto, in the foregoing embodiment, the segment is additively manufactured through electron beam melting that relieves plastic deformation stress.

In the alternative or additionally thereto, in the foregoing embodiment, the segment is additively manufactured through electron beam melting that relieves plastic deformation stress.

In the alternative or additionally thereto, in the foregoing embodiment, the segment is additively manufactured through electron beam melting that relieves plastic deformation stress.

A method of manufacturing a folded sheet assembly according to another, non-limiting, embodiment includes the steps of pre-determining a bend-line along a sheet of material; bending the sheet along the bend-line; and additively manufacturing a segment upon a bend at the bend-line.

Additionally to the foregoing embodiment, the bending creates residual stress at the bend and the additively manufactured segment is produced through a heat gun that relieves the residual stress.

In the alternative or additionally thereto, in the foregoing embodiment, the method includes the step of forming a perforation in the sheet along the bend-line prior to bending.

In the alternative or additionally thereto, in the foregoing embodiment, the segment fills an aperture proximate to the bend-line.

In the alternative or additionally thereto, in the foregoing embodiment, the perforation is defined between two opposing edge faces and the segment is additively manufactured to the edge faces.

In the alternative or additionally thereto, in the foregoing embodiment, the additively manufactured segment is cold sprayed.

In the alternative or additionally thereto, in the foregoing embodiment, the assembly is a fluid tight enclosure.

The foregoing features and elements may be combined in various combinations without exclusivity, unless expressly indicated otherwise. These features and elements as well as the operation thereof will become more apparent in-light of the following description and the accompanying drawings. It should be understood, however, the following description and figures are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a plan view of a sheet in an un-folded state of a folded sheet assembly;

FIG. 2 is a cross section of the folded sheet assembly taken along line 2-2 of FIG. 1;

FIG. 3 is a cross section of the folded sheet assembly taken along line 3-3 of FIG. 1;

FIG. 4 is a plan view of a second embodiment of a sheet in an un-folded state of a folded sheet assembly;

FIG. 5 is a side view of the folded sheet assembly;

FIG. 6 is a cross section of the folded sheet assembly taken along line 6-6 of FIG. 5; and

FIG. 7 is a flow chart of a method of manufacturing a folded sheet assembly.

### DETAILED DESCRIPTION

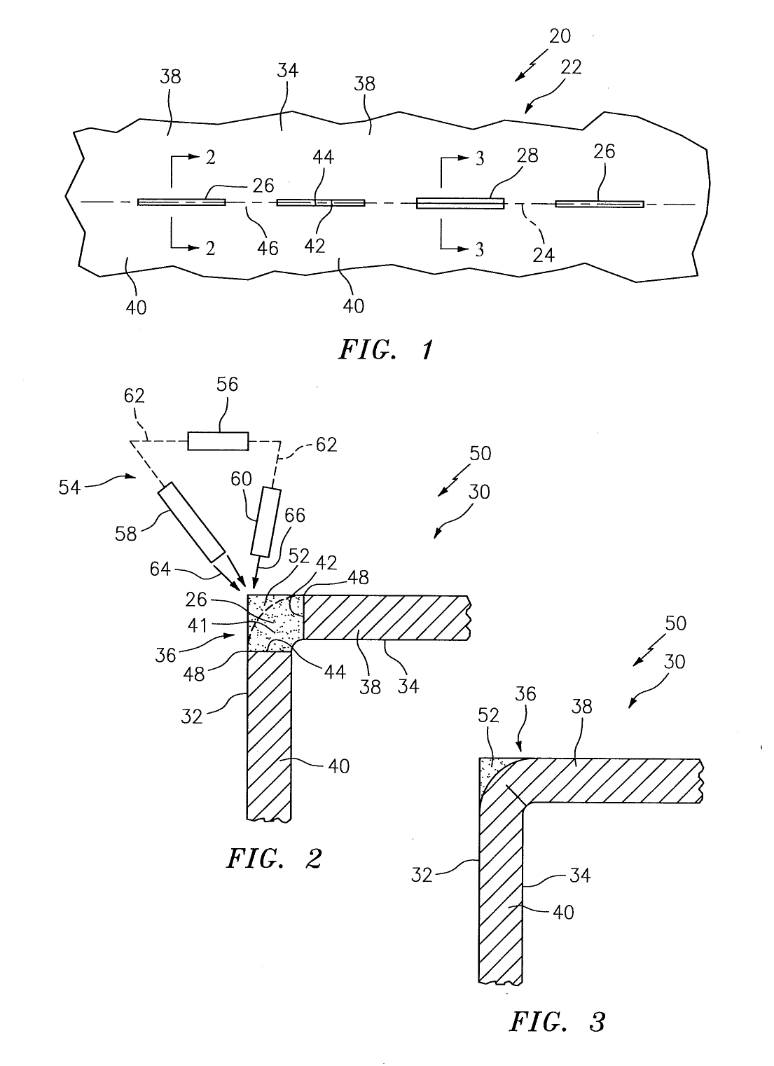

Referring to FIG. 1, an example of a substantially planar sheet 20 is illustrated in a un-folded state 22 and having a pre-determined bend-line 24. The sheet 20 may be a metal, alloy, polymer or composite sheet, and may have a plurality of slits or perforations 26 and/or at least one groove 28 positioned along the bend-line 24 to assist in the bending or folding of the sheet 20 along the bend-line 24 and into a folded state 30 (see FIGS. 2 and 3). The sheet 20 has an outer side 32 and an opposite inner side 34 with the groove 28 generally defined by the inner side 34. When in the folded state 30, a resultant bend 36 along the bend-line 24 generally connects a first portion 38 to a second portion 40 of the sheet 20 that are in angular relationship to one-another.

When in the un-folded state 22, the slits 26 are each defined by opposing edge faces 42, 44 carried by the respective first and second portions 38, 40 of the sheet 20. When in the folded state 30, the edge faces 42, 44, or any portion thereof, may or may not oppose one-another and are proximate to, or generally in, the bend 36. Furthermore, the slits 26 may communicate through the sheet 20 even when in the folded state 30 or may otherwise reposition and open up further apertures 41 that communicate through the sheet. The folding process plastically deforms a base material segment 46 of the sheet 20 that is in or crosses through the bend 36 and generally maintains engagement of the first and second portions 38, 40. When deformed, the base material segment 46 may have residual stress that is particularly prominent at and near the outer side 32 (i.e. tension). This stress, along with the slits and grooves 26, 28, structurally weakens the bend 36 and may further promote corrosion at the bend location. Furthermore, undesirable sharp edges 48 may be formed where the edge faces 34, 36 meet the outer side 32.

Referring to FIG. 2, a folded sheet assembly 50 is illustrated having the sheet 20 when in the folded state 30 and an additive manufactured filler material or segment 52. Segment 52 is additive manufactured directly to the bend 36. The segment 52 may further be formed directly to the edge faces 42, 44 and/or base material segment(s) 46 (see FIG. 1) thereby filling the slits 26 and or apertures 41 creating a more structurally sound bend 36. As best shown in FIG. 3 and alternatively or in addition thereto, the segment 52 may be formed directly to the outer side 32 of the sheet 20. Segment 52 may also be located on the inside of the bend 36. After the additive manufacturing process is complete, the segment 52 and/or bend 36 may be machined, or otherwise modified, to form the desired or aesthetically pleasing shape. The folded sheet assembly 50 may be any type of final product including bended electrical terminals, electrical boxes, fluid tight enclosures, transportation type enclosures, storage enclosures, structural elements and/or any type of product where precision bending and a structurally rigid assembly is desired.

An additive manufacturing system 54 used to apply the segment 52 to the sheet 20 when in the folded state 30 may be any number of systems generally known in the art, including Cold Spray or Kinetic Metallization, Cold Metal Transfer (CMT), Additive Layer Manufacturing (ALM) devices, such as Direct Metal Laser Sintering (DMLS), Selective Laser Melting (SLM), Laser Beam Melting (LBM), Electron Beam Melting (EBM), or other suitable solid freeform fabrication method, and which may provide for the fabrication of metal, alloy, polymer, ceramic and composite structures by the freeform construction of the segment 52. Each system 54 may have a controller 56 that generally operates an energy gun 58 and a powder, wire or strip delivery system 60 through electrical signals 62.

If the additive manufacturing system 54 utilizes the Cold Spray or Kinetic Metallization technology, a raw material or powder 66 is typically applied to the sheet 20 at supersonic speeds thus the energy gun 58 and the powder delivery system 60 are generally integrated. Such systems do not require a vacuum to operate, and do not intentionally create or require melting, thus are less prone to solidification defects. Moreover, the raw material may be of a different composition than the base material, and a durable bond can still be formed through particle-to-particle impact. Although not shown, the controller 56 may be part of, or control a robotic arm that senses and moves the energy gun 58 and delivery system 60 along the bend 36. The system 54 is relatively simple and may be generally portable making Cold Spray or Kinetic Metallization an ideal choice for larger and bulkier assemblies 50. It is further contemplated and understood that similar example descriptions may apply to wire feed and cold metal transfer technologies.

Alternatively, the energy gun 56 may be an electron beam or laser energy gun. The principle behind such additive manufacturing systems involves the selective melting of atomized precursors, powder beds, powder spray, or wire feed 66 (as examples) by the energy gun 58, producing a build-up of the segment 52. For instance, and when applying a laser or electron energy beam, melting of the powder or wire occurs in a small localized region of an energy beam 64, producing small volumes of melting, called melt pools, followed by rapid solidification, allowing for very precise control of the solidification process in a layer-by-layer fabrication of the segment 52. The controller 56 may be directed by three-dimensional geometry solid models developed in Computer Aided Design (CAD) software systems. The heating and melting aspect of the electron beam and laser energy guns will heat and melt a small portion of the base material, thereby relieving residual stresses created during plastic deformation of the base material segments 46 of the sheet 20.

Non-limiting examples of the feed wire, strip or powder may include ceramics, metals, polymers, carbon-based materials or a mixture of ceramic, polymer, carbon and/or metal. Non-limiting examples of ceramics may include oxide ceramics such as Al₂O₃ or ZrO₂, carbide materials such as silicon carbide and boron carbide, and nitride ceramics such as aluminum nitride, silicon nitride. Non-limiting examples of metals may include nickel or nickel alloys, titanium or titanium alloys, cobalt and cobalt alloys, copper and copper alloys, ferrous metals such as steel alloys, stainless steel, and non-ferrous metals such as aluminum, aluminum alloys, and bronze. Non-limiting examples of mixtures may include aluminum-silicon metal matrix composites, carbon nanotube-filled copper, WC—Co cermets, polymer encapsulated SiC powders, and polymer-precursor blends containing aluminum powders.

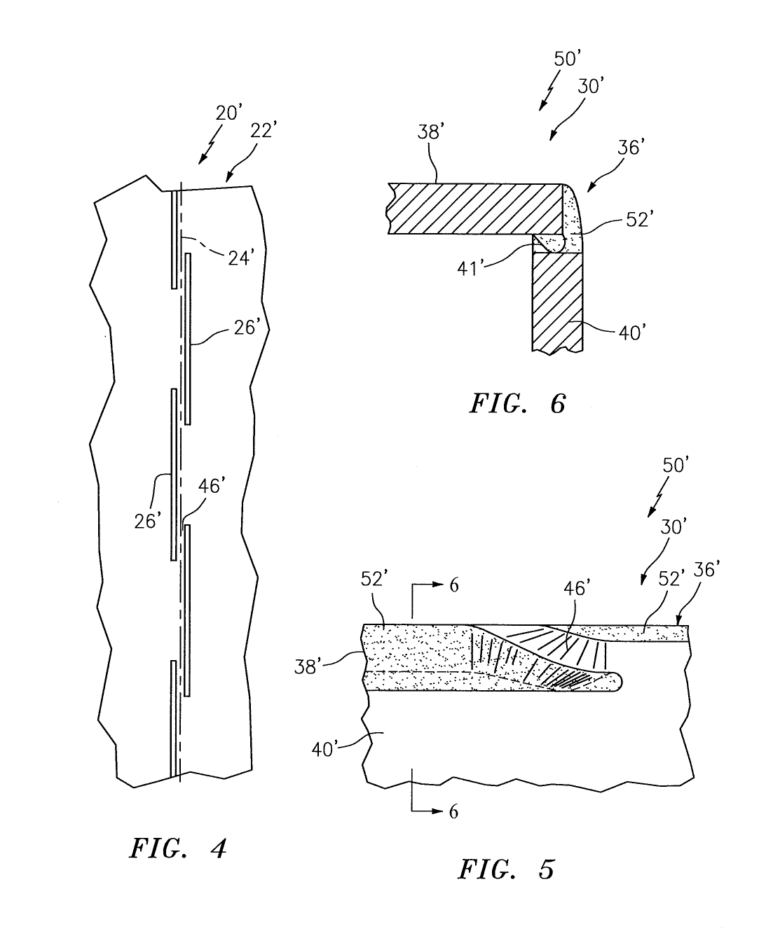

Referring to FIGS. 4 through 6, a second embodiment of a folded sheet assembly is illustrated wherein like elements have like identifying numerals except with the addition of a prime symbol. A sheet 20′ in the un-folded state 22′ has a plurality of slits 26′ that co-extend longitudinally along a bend-line 24′. Each slit 26′ is laterally offset, but proximate to, the bend-line 24′ and such that one slit is located on one side of the bend-line and the next adjacent slit is located on the other side of the bend-line. Moreover, each slit 26′ longitudinally overlaps the next adjacent slit and thereby defines a base material segment 46′ there-between.

When in a folded state 30′, a resultant bend 36′ along the bend-line 24′ generally connects a first portion 38′ to a second portion 40′ of the sheet 20′ that are in angular relationship to one-another. An additive manufactured segment 52′ is formed directly to the portions 38′, 40′ at the bend 36′ and fills at least a portion of the slits 26′ and any resulting apertures 41′ formed as a result of the bending process. The sheet 20′ in the folded state 30′ and the segment 52′ together form a folded sheet assembly 50′.

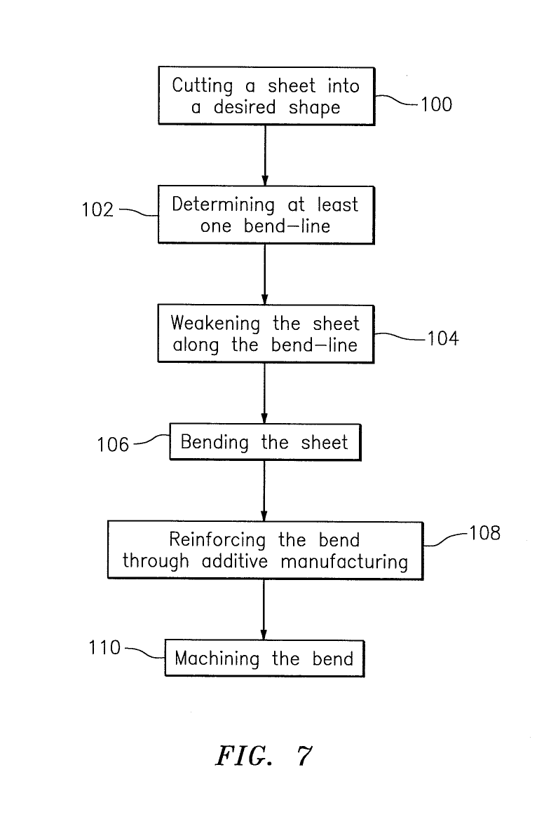

Referring to FIG. 7, a method of manufacturing a folded sheet assembly 50, 50′ may include an initial step 100 of cutting a substantially planar sheet 20, 20′ to a pre-determined size and shape using a non-limiting exemplary process such as embossing, cutting, slitting, grooving or stamping. Step 102 includes pre-defining at least one bend-line 24, 24′, then at step 104, weakening an area of the sheet 20, 20′ along the bend-line 24, 24′ through the formation of perforations, slits, stamped regions, and/or grooves 26, 26′, 28, 28′. The next step 106 is bending the sheet 20, 20′ along the bend line 24, 24′ thereby causing plastic deformation of a base material segment 46, 46′ located proximate to the bend 36, 36′. Once the sheet is bended, step 108 includes reinforcing the bend 36, 36′ by additively manufacturing a segment 52, 52′ directly to the sheet 20, 20′ and in any perforations 26, 26′ and/or apertures 41, 41′ in the sheet 20, 20′. As a final step 110, the bend 36, 36′ and/or the segment 52, 52′ may be machined, or otherwise post processed, to contour the reinforced bend into a desirable shape and surface texture, or to impart other desirable properties to the sheet or additive manufactured segment or bend.

It is understood that relative positional terms such as “forward,” “aft,” “upper,” “lower,” “above,” “below,” and the like are with reference to the normal operational attitude and should not be considered otherwise limiting. It is also understood that like reference numerals identify corresponding or similar elements throughout the several drawings. It should be understood that although a particular component arrangement is disclosed in the illustrated embodiment, other arrangements will also benefit. Although particular step sequences may be shown, described, and claimed, it is understood that steps may be performed in any order, separated or combined unless otherwise indicated and will still benefit from the present disclosure.

The foregoing description is exemplary rather than defined by the limitations described. Various non-limiting embodiments are disclosed; however, one of ordinary skill in the art would recognize that various modifications and variations in light of the above teachings will fall within the scope of the appended claims. It is therefore understood that within the scope of the appended claims, the disclosure may be practiced other than as specifically described. For this reason, the appended claims should be studied to determine true scope and content.

What is claimed is:

1. A folded sheet assembly comprising:
a bend; and
an additive manufactured segment located at the bend.

2. The folded sheet assembly set forth in claim 1, wherein a perforation is located along the bend and the segment fills at least a portion of the perforation.

3. The folded sheet assembly set forth in claim 1 further comprising:
a first sheet portion having a first edge face proximate to the bend;
a second sheet portion engaged to the first sheet portion at the bend, and having a second edge face proximate to the bend; and
wherein the segment is additively manufactured to at least the first and second edge faces.

4. The folded sheet assembly set forth in claim 1 further comprising:
an inner side defining a groove extending along the bend;
an outer side generally in plastic deformation along the bend; and
wherein the segment is additively manufactured to the second side at the bend.

5. The folded sheet assembly set forth in claim 2, wherein the segment is cold sprayed.

6. The folded sheet assembly set forth in claim 3, wherein the segment is produced through Kinetic Metallization.

7. The folded sheet assembly set forth in claim 4, wherein the segment is cold sprayed.

8. The folded sheet assembly set forth in claim 2, wherein the segment is produced through cold metal transfer.

9. The folded sheet assembly set forth in claim 3, wherein the segment is additively manufactured through laser beam melting that relieves plastic deformation stress.

10. The folded sheet assembly set forth in claim 4, wherein the segment is additively manufactured through laser beam melting that relieves plastic deformation stress.

11. The folded sheet assembly set forth in claim 2, wherein the segment is additively manufactured through electron beam melting that relieves plastic deformation stress.

12. The folded sheet assembly set forth in claim 3, wherein the segment is additively manufactured through electron beam melting that relieves plastic deformation stress.

13. The folded sheet assembly set forth in claim 4, wherein the segment is additively manufactured through electron beam melting that relieves plastic deformation stress.

14. A method of manufacturing a folded sheet assembly comprising the steps of:
pre-determining a bend-line along a sheet of material;
bending the sheet along the bend-line; and
additively manufacturing a segment upon a bend at the bend-line.

15. The method set forth in claim 14, wherein the bending creates residual stress at the bend and the additively manufactured segment is produced through a heat gun that relieves the residual stress.

16. The method set forth in claim 14 comprising the further step of:
forming a perforation in the sheet along the bend-line prior to bending.

17. The method set forth in claim 16, wherein the segment fills an aperture proximate to the bend-line.

18. The method set forth in claim 16, wherein the perforation is defined between two opposing edge faces and the segment is additively manufactured to the edge faces.

19. The method set forth in claim 14, wherein the additively manufactured segment is cold sprayed.

20. The method set forth in claim 14, wherein the assembly is a fluid tight enclosure.
